(19) United States
(12) Patent Application Publication
(10) Pub. No.: US 2021/0040820 A1
(43) Pub. Date: Feb. 11, 2021

(54) DRILLING RIG EMEREGENCY STOP AND LOCKOUT SYSTEM

(71) Applicant: Schlumberger Technology Corporation, Sugar Land, TX (US)

(72) Inventor: Anstein JORUD, Kristiansand (NO)

(21) Appl. No.: 16/531,283

(22) Filed: Aug. 5, 2019

(51) Int. Cl. E21B 41/00; G05B 19/05

(52) U.S. Cl. CPC E21B 41/00; G05B 2219/14116; G05B 19/058

(57) ABSTRACT

Systems and methods for controlling stoppage of a drilling rig, of which the method includes pairing a stop indicator with a type of stoppage, a rig system to shutdown, or both, receiving a request to change the type of stoppage, rig system, or both paired with the stop indicator, and in response to receiving the request, changing the type of stoppage, the rig system to shutdown, or both associated with the stop indicator, without changing a wiring of the drilling rig.

### BACKGROUND

Drilling rigs employ many hydraulic, pneumatic, mechanical, and electromechanical systems, working together to advance a drill string, including a drill bit, into the earth in order to create a well. The rigs may use additional equipment to run casing into the well, and still more equipment to run cement through the casing and into the annulus formed between the casing and the wellbore. Rigs may also employ such systems for wireline operations, formation treatments, etc.

The machinery involved is large and can involve high fluid pressure and high electrical loads. The safety of the rig personnel is a priority. Rigs thus include safety-stop mechanisms. Generally, these are buttons that are positioned at various strategic locations around the rig. If the buttons are pressed, an emergency stop is initiated, which shuts down a nearby system or potentially the entire rig, in response. Specifically, pressing an emergency stop button can trigger a hierarchical response based on which button is pressed. For example, pressing one emergency button may make only one nearby system stop, whereas pressing a different button may stop one nearby system, as well as another system, e.g., where the latter system is dependent upon the former system. These hierarchies are predetermined and hardwired, e.g., by pressing a button, a relay is tripped and a circuit is completed that initiates a shutdown on one system, which may cause another circuit to complete and initiate a second shutdown, etc.

While reliable, these buttons and hierarchies result in a large amount of wires run through the rig. Further, the number and size of the cables can impose a physical limit on the different actions that can be taken in response to a user pressing a button. Moreover, changing the hierarchy can be time-consuming, as the hardwired connections may have to be changed to accommodate any changes in the shutdown logic.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A shutdown system for a drilling rig includes a plurality of rig system controllers configured to communicate with respective rig systems of a plurality of rig systems of the drilling rig, to control operation thereof, and a stop controller in communication with the plurality of rig system controllers. The stop controller is configured to selectively cause the plurality of rig system controllers to stop operation of the respective rig systems. The system also includes a stop indicator in wireless communication with the stop controller. The stop indicator is configured to transmit a stop message to the stop controller. The stop controller is configured to determine a type of stoppage, a particular system to shutdown, or a combination thereof based at least in part on the stop message, and, in response, to cause one or more of the plurality of rig system controllers to shutdown one or more of the rig systems.

A method for controlling stoppage of a drilling rig includes pairing a stop indicator with a type of stoppage, a rig system to shutdown, or both, receiving a request to change the type of stoppage, rig system, or both paired with the stop indicator, and in response to receiving the request, changing the type of stoppage, the rig system to shutdown, or both associated with the stop indicator, without changing a wiring of the drilling rig.

A non-transitory, computer-readable medium storing instructions that, when executed by one or more processors of a computing system, causing the computing system to perform operations, the operations including pairing a stop indicator of a drilling rig with a type of stoppage, a rig system to shutdown, or both, of the drilling rig, receiving a request to change the type of stoppage, rig system, or both paired with the stop indicator, and in response to receiving the request, changing the type of stoppage, the rig system to shutdown, or both associated with the stop indicator, without changing a wiring of the drilling rig.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a conceptual, schematic view of a control system for a drilling rig, according to an embodiment.

FIG. 2 illustrates a conceptual, schematic view of the control system, according to an embodiment.

FIG. 3 illustrates a schematic view of an emergency stop system, according to an embodiment.

FIG. 4 illustrates a flowchart of a method for associating stop indicators with actions, according to an embodiment.

FIG. 5 illustrates a flowchart of a method for stopping one or more rig systems in response to a stop signal, according to an embodiment.

FIG. 6 illustrates a computing system for performing at least a portion of the method, according to an embodiment.

### DETAILED DESCRIPTION

### Introduction

Embodiments of the systems and methods disclosed herein provide the ability for rig stop/shutdown logic to be implemented and changed on-the-fly, using software changes at least partially in lieu of hardwired implementations. For example, the level of shutdown, as well as the systems that are shutdown or stopped in response to a particular stop message may be changed by adjusting a database that associates the stop message with an action, such as a type of stoppage, a rig system to be shutdown, or both. The system may employ a dedicated stop controller, which manages how stop messages are handled, and is able to communicate with other rig system controllers to shutdown, stop, or isolate the various rig systems. In addition, the stop indicators may be implemented as physical buttons or in computing devices, either of which may be in wireless communication with the stop controller. In an embodiment, the rig system controllers may be arranged in a ring network topology, and thus rig systems may be configured to communicate with one another and with the stop controller, such that the stop controller is able to communicate with each of the rig system controllers as part of the network. Additional aspects of the disclosure, as well as a more detailed explanation of those aspects presented above, is described herein below.

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items.

It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Rig Environment

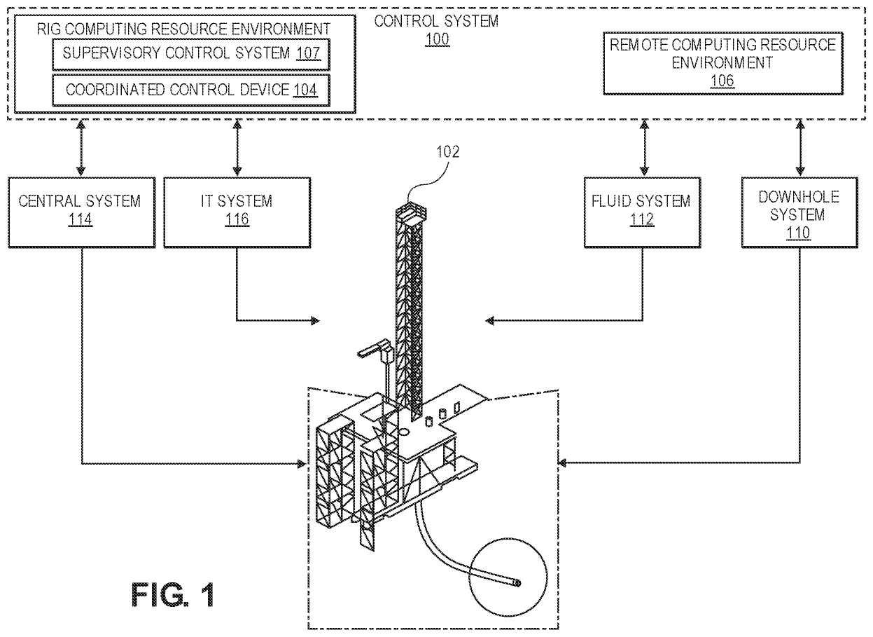

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

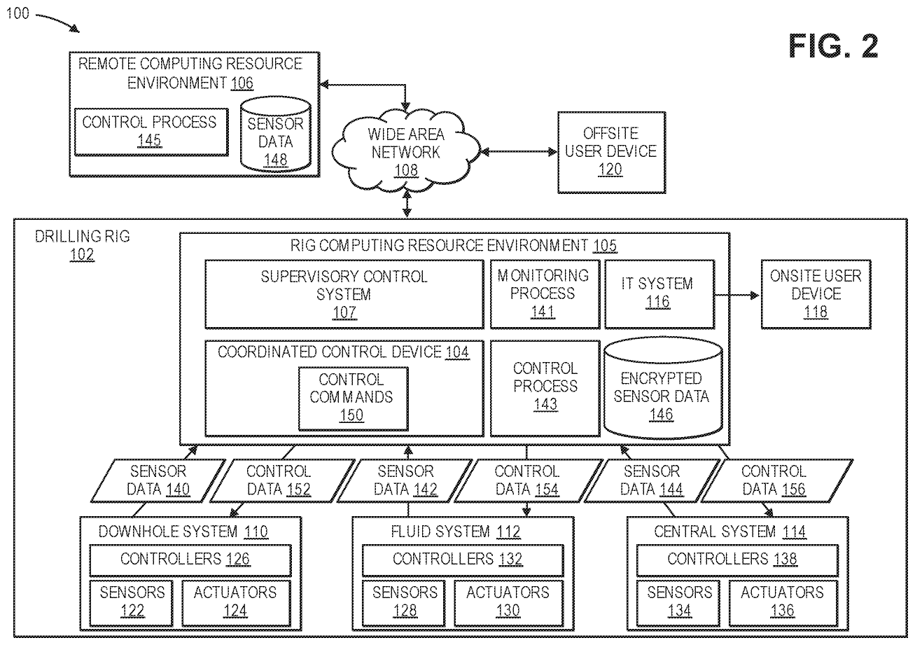

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g., 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

The systems and methods disclosed herein track and monitor performance and health of a rig's tubular handling system (THS). The systems and methods may utilize sensor data and time-stamps to measure and/or determine the position, speed, acceleration, and/or force/loading of one or more rig sequences. Reaction times, performance, health indexes, and degradation may be determined based at least partially upon these measurements/determinations. In response, an alarm may be triggered and/or a maintenance activity may be initiated, to ensure that the rig's tubular handling system operates within equipment limits.

The tubular handling system may include one or more mechanical systems that perform movement and grabbing functions. The mechanical systems may include arms, joints, and actuators. The control system 100, such as the one described above with regard to FIGS. 1 and 2, is utilized to execute the commands to synchronize movements in the sequence to perform a given activity. Feedback to the control system 100 is given by sensors located at multiple locations within the THS.

Emergency Stop System

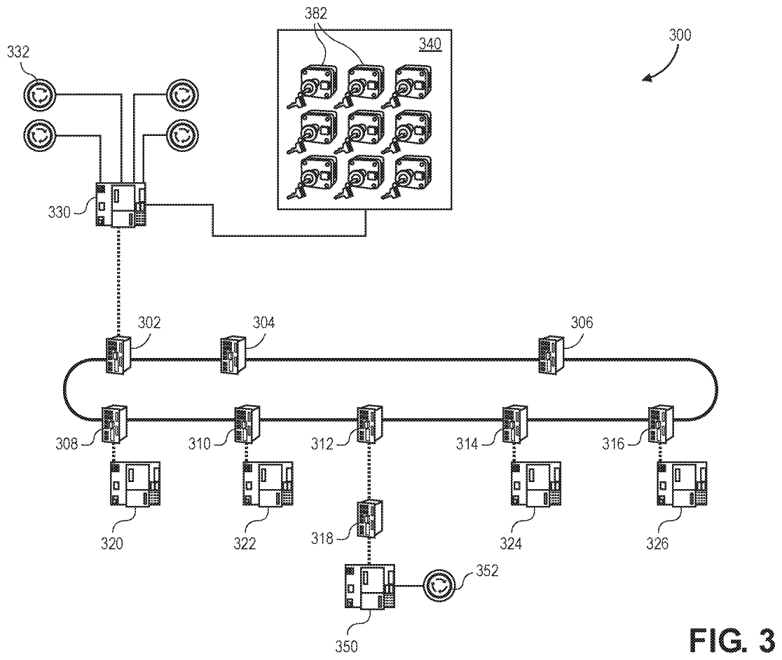

FIG. 3 illustrates a schematic view of an emergency stop system 300 for a drilling rig, according to an embodiment. The emergency stop system 300 may be integrated into any one or more of the control systems discussed above. The emergency stop system 300 may include a plurality of input/output (I/O) modules 302, 304, 306, 308, 310, 314, 316, 318 (collectively, 302-318), a plurality of rig system controllers 320, 322, 324, 326 (collectively, 320-326), a dedicated stop controller 330, a plurality of first stop indicators 332, and a centralized lockout panel 340.

The stop indicators 332 may be in wireless communication with the stop controller 330, e.g., via WIFI® or BLUETOOTH® connectivity, although any wireless communication protocol may be employed. The stop indicators 332 may be configured to send “stop messages” to the stop controller 330, which the stop controller 330 may respond to and implement as discussed in greater detail below.

In some embodiments, the stop indicators 332 may be provided by computing devices executing an application that causes the computing devices to interface with the dedicated stop controller 330. For example, one, some, or each of the stop indicators 332 may be provided by a smartphone, laptop, tablet computing device, and/or the like. Such computing devices providing the stop indicators 332 may provide a display that enables multiple different commands to be entered by a single stop indicator 332. For example, different levels of shutdowns may be entered into a single indicator 332, as will be described in greater detail below. Furthermore, specific rig systems may be targeted for isolation or otherwise shutdown/stopped, from any position on, or even remote from, the rig (e.g., via communication through a wide-area network such as the internet). As such, some of the stop indicators may not be located on or at the drilling rig.

In some embodiments, the stop indicators 332 may be physical buttons or a mix of computing devices and physical buttons. The physical button may be mounted on a wall, post, door, or another physical structure of the rig. In another embodiment, the physical button may be worn (e.g., as a fob) on one or more rig personnel.

The dedicated stop controller 330 may be a programmable logic controller executing software that is configured to verify and give effect to instructions received from the indicators 332. For example, the dedicated stop controller 330 may be configured to cause the individual rig controllers 320-328 to electrically and/or mechanically stop or shutdown various individual rig components and/or systems, and may be able to stop all rig activity, as with a blackout shutdown. Further, the dedicated stop controller 330 may be able to communicate with and activate a siren or another type of auditory or visual, etc., alarm device that provides notification to rig personnel that an emergency stop is underway.

The individual indicators 332 may be associated with an identifier (e.g., a name, identification number, username, location, etc.) in a database accessible to the stop controller 330. This identifier may, in turn, be associated (paired) with a particular type of stoppage, a rig system to be shutdown, or a combination thereof. Thus, when a stop message is received from an individual one of the indicators 332, it may be matched by identifier to the action to be taken by the association in the database. In some embodiments, the stop indicator 332 may be configured to provide stop messages requesting one of several types of shutdowns, systems to shut down, or both. Thus, the stop message may include not only an identifier but an action to take.

Further, in some embodiments, the indicators 332 may each be associated with an authority level. Each of the systems and types of shutdowns may be associated with an authority level requirement. Thus, the stop controller 330 may be configured to first verity whether, upon receiving a stop message from one of the indicators 332, that the indicator 332 has sufficient authority (i.e., meeting or exceeding the authority requirement) to execute a requested shutdown level, or particular system to shutdown, etc. as indicated by the stop message, and either give effect to the stop message or deny it.

The rig system controllers 320-326 may be in communication with one another and/or with the dedicated stop controller 330 via the I/O modules 302-318. In a specific embodiment, as shown, at least some of the I/O modules 302-318 may be arranged in a ring network topology, enabling communication with one another. The I/O modules 302-318 may be in communication with one another via wired and/or wireless communication links. Further, the rig system controllers 320-326 may be in wired or wireless communication with one or more individual rig systems, e.g., via electromechanical relays or switches. Accordingly, among other control activities, the controllers 320-326 may be configured to electrically and/or mechanically stop and/or shutdown the rig systems under their control.

The ring network topology may allow for a single connection between the dedicated stop controller 330 and one of the I/O modules 302 to enable communication between all of the rig system controllers 320-326. In the case where one or more of the rig controllers are disconnected, bypass communication may be provided, e.g., through a human-machine interface.

In some embodiments, a second stop control module 350 may be included in the system 300. A second indicator 352 may be configured to communicate with the second stop control module 350. The second indicator 352 may be a computing device or a physical button and may be in wireless communication with the second stop control module 350. The second indicator 352 may thus interface with the second stop control module 350 and provide commands thereto, which may include different levels of stoppage, different individual systems to stop, etc.

In some embodiments, the system 300 may also include the centralized lockout panel 340, as mentioned above. The lockout panel 340 may include a plurality of third indicators 382. These third indicators 382 may communicate with (e.g., be hardwired to) the dedicated stop controller 330 and may, for example, correspond to different stoppage levels, different systems to be stopped, etc. As such, actuating one of the indicators 382 may have a different effect than actuating another one of the indicators 382. The effect of actuating the different third indicators 382 may be implemented in software executed by the dedicated stop controller 330. For example, each of the third indicators 382 may correspond to a different port in the stop controller 330, and communication received at each different port may be associated with a different stoppage action.

Methods for Operating the Emergency Stop System

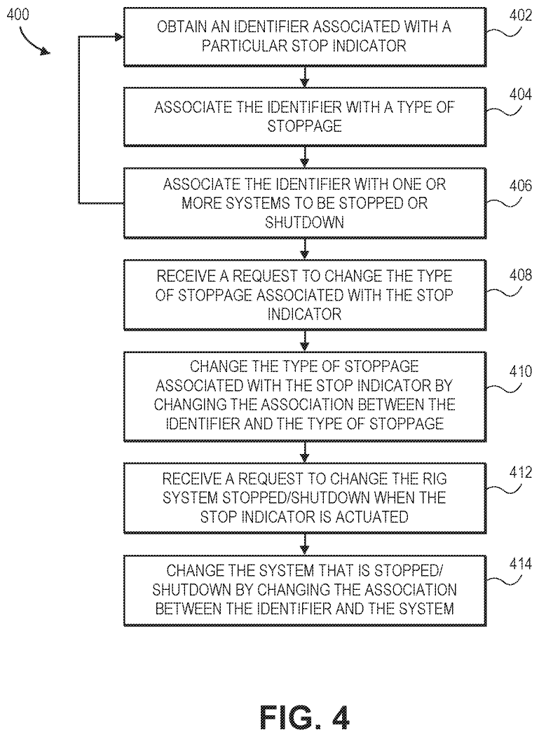

FIG. 4 illustrates a flowchart of a method 400 for controlling a drilling rig, e.g., associating stoppages with stop indicators, according to an embodiment. This method 400 may reflect a software application, implemented as computer instructions executed using, for example, the stop controller 330 discussed above, although the method 400 may also be implemented as hardware.

The method 400 may pair the stop identifiers 332 with one or more stoppage actions. For example, the method 400 may include receiving an identifier associated with a particular stop indicator 332, as at 402. The identifier may be provided by the stop indicator 332, e.g., as a variable (e.g., an address, serial number, etc.) that is passed to the stop controller 330 along with an initialization message. In other embodiments, the stop controller 330 may assign the identifier to the stop indicator 332. The variable may be assigned in any number of ways, according to any one of various handshake protocols for initialization communication between two devices. The identifier may be unique to the stop indicator, so that individual stop indicators may be referenced by the stop controller 330.

The identifier (and thus the stop indicator that it represents) may then be associated with a type of stoppage, as at 404. This may be implemented using a database, which may be accessible to the stop controller 330, and may be read and/or edited by the stop controller 330. The type of stoppage may be, for example, a blackout shutdown, an emergency shutdown, an e-stop, or a system isolation. Furthermore, the type of stoppage may include a duration, a type of alarm, indication of a rally point for rig personnel, etc.

The identifier may also be associated with one or more systems to be shutdown, as at 406. The systems may include directly affected components. In some embodiments, the systems may include indirectly affected components, i.e., those that are dependent upon the directly affected components. Furthermore, a shutdown sequence of different systems may be specified and associated with the identifier in the database.

The database may be populated in this way iteratively, such that the identifiers for the various stop indicators are associated with actions that include a type of stoppage and one or more systems to be shutdown/stopped. As mentioned above, authority levels may also be set for the different stop indicators. Additional stop indicators may also be added to the system using this loop. Further, it will be appreciated that a single stop indicator may be associated with several different stoppage actions and/or identifiers, e.g., representing different types of stop messages that may be received from a single computing device providing the stop indicator.

At some point, an operator or administrator may determine that the action associated with the stop indicator should be changed. In previous systems, such a change may have involved a rewiring effort to wire the stop indicator to the associated rig system or its controller. However, in present systems and methods may facilitate such changes through manipulation of the database rather than wiring (although, some wiring changes may be used as well). For example, the method 400 may include receiving a request to change the type of stoppage associated with the stop indicator, as at 408. Such a request may be received from the stop indicator itself (e.g., in a computing device implementation of the stop indicator), by direct entry through a human-machine interface provided by the stop controller 330, or otherwise provided to the stop controller 330. The stop controller 330 may, in response, change the type of stoppage associated with the stop indicator by changing, in the database, the association between the identifier associated with the stop indicator and the type of stoppage, as at 410.

Further, the method 400 may additionally or instead include receiving a request to change the rig system to be stopped or shutdown when the stop indicator (e.g., a “stop message”) is actuated, as at 412. Here again, this request may be received at the stop controller 330 from the stop indicator 332, another device, or directly through an interface provided by the stop controller 330. Further, a software change may be used to implement the requested change. For example, the stop controller 330 may change the system that is stopped or shutdown by changing, in the database, the association between the identifier associated with the stop indicator and the system, as at 414.

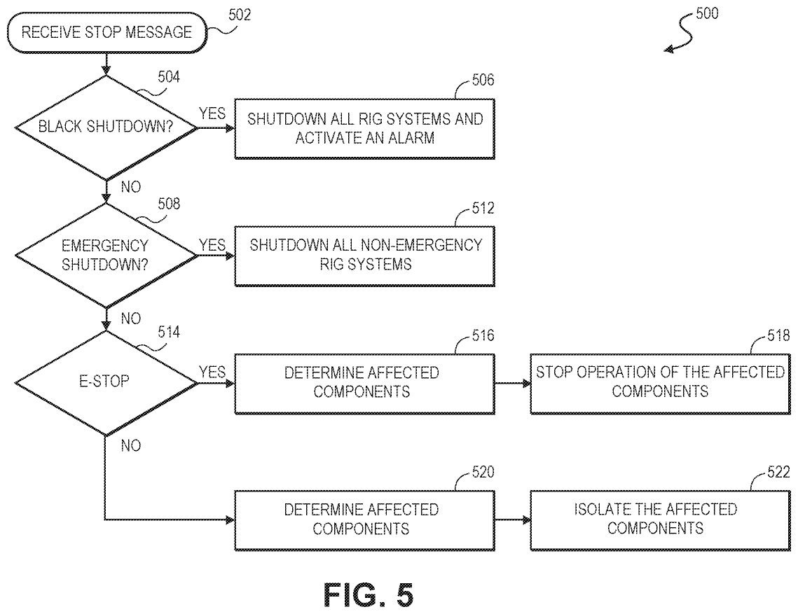

FIG. 5 illustrates a flowchart of a method 500 for controlling stoppage in a rig control system, according to an embodiment. The method 500 may be executed, for example, using the system 300, and particularly, using the stop controller 330. However, it will be appreciated that various embodiments of the method 500 may be executed using other types of components and/or systems.

The method 500 may include receiving a stop message or “input”, as at 502. Thus, the method 500 may operate based on an interrupt signal, which may be received from any one of the stop indicators 332 at the stop controller 330. In another embodiment, the stop controller 330 may poll for stop messages periodically, or such stop messages may be otherwise detected and received by the stop controller 330.

The stop message may include information, which may be related to the identity of the stop indicator and/or information entered or otherwise selected by a user of the stop indicator. For example, the stop indicator may be associated in a database with a particular type of stoppage, a particular system (or systems), or the like. In another embodiment, the stop message may include an indication of a particular type of stoppage, a particular system (or systems) to be shutdown, or the like. In either case, the stop indicator may thus provide information sufficient for the stop controller 330 to provide a desired shutdown level of one or more particular systems.

In some embodiments, the stop controller 330 may determine if the stop indicator from which the stop message was received has sufficient authority to cause the desired stoppage/shutdown, e.g., based on an assigned authority level.

The stop controller 330 may then proceed to determining if a “black” shutdown (which may also be referred to as an “abandon rig shutdown” (ARS)) is requested as part of the stop indicator, as at 504. A black shutdown may be the highest level of shutdown available, with the desired effect being a total shutdown of the rig systems and an evacuation of personnel from the rig. Accordingly, in response to determining that a black shutdown is requested, the method 500 may proceed to shutting down all rig equipment and sounding an alarm, as at 506. As such, both normal and emergency equipment may be taken offline/powered-down, including stopping of generators (e.g., with the exception of uninterruptable power sources). Ignition sources on the rig may also be isolated. Further, rig personnel may be directed to evacuate from the rig, e.g., to an external rally point.

If it is determined that a black shutdown is not requested as part of the stop message, the method 500 may proceed to determining if an emergency shutdown is requested as part of the stop message, as at 508. It will be appreciated that such determination may be simultaneous to the determination of a black shutdown. For example, the level of shutdown may be a numerical value of a variable, e.g., where 1 is a black shutdown, 2 is an emergency shutdown, 3 is an e-stop, 4 is maintenance (these examples are merely for illustration—any numbers may be used). In another example, the determinations may be made sequentially according to the illustrated sequence or any other.

If an emergency shutdown is requested, the method 500 may proceed to shutting down all non-critical (to avoid hazardous conditions) rig systems, as at 512. In an emergency shutdown, the rig is stopped and non-critical components are powered down. An emergency shutdown may result in the main rig power feed and auxiliary power feed from the pressure control skid being shutdown. Further, ignition sources in the rig may be isolated. However, the well may continue to be secured by emergency equipment, as defined by, for example, governmental regulations.

Shutting the components down may include isolating the affected components from any type of energy, whether electrical, mechanical, hydraulic, pneumatic, etc. For example, a relay may be opened to prevent electrical current from reaching the affected component, or a valve may be closed to prevent hydraulic communication therewith, etc. In some embodiments, various other systems may be likewise shutdown. Such systems may be those systems that are dependent upon the affected systems. Further, these systems can be identified and/or changed as part of the logic implemented by the stop controller 330 executing the method 500.

If an emergency stop was not requested, the method 500 may proceed to determining an e-stop was requested, as at 514. Again, this determination may not be sequential, but rather simultaneous to the determinations at 504 and 508. In response to an e-stop being requested, the method 500 may proceed to determining affected components at 516 and shutting down at least the affected components at 518. The affected components may be malfunctioning, or involved in a situation where the continued use of these components may be hazardous either to the operation of the rig equipment or the personnel. In an e-stop situation, a single system or even a single component may be powered down, while the rest of the rig equipment remains operational. In addition, indirectly affected rig systems, e.g., those that rely on or work in coordination with the affected rig systems may also be shutdown, e.g., as part of a hierarchy.

If none of the above shutdowns or stops were requested, the method 500 may determine, or default to, an isolation of one of the systems, e.g., for maintenance purposes. For example, one or more systems, or sub-systems, may be taken offline for repairs, replacing components thereof, etc. Accordingly, upon receiving an isolation request via the stop message, the method 500 may proceed to determining affected components, as at 520. The components may then be isolated, as at 522, e.g., by disconnecting power (whether electrical, hydraulic, pneumatic, etc.), which allows maintenance of the components.

Computing Environment

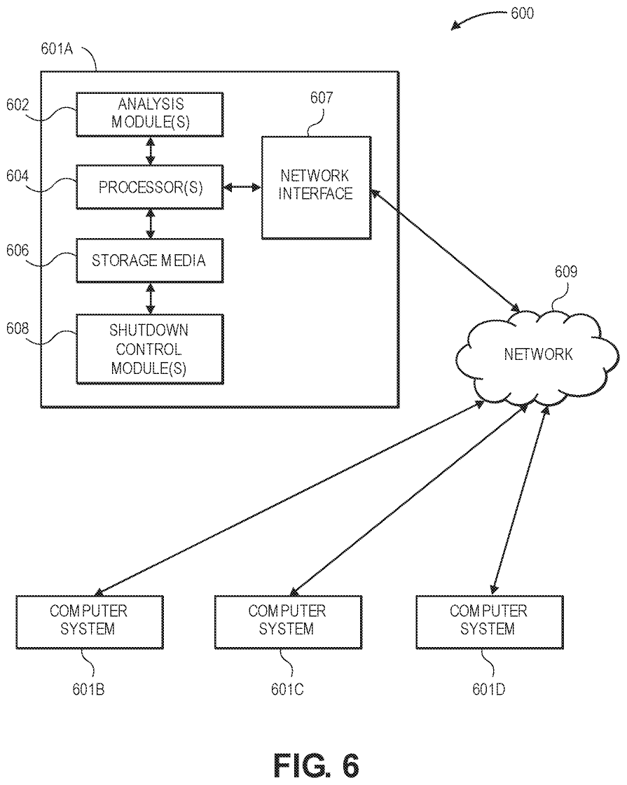

In some embodiments, the methods of the present disclosure may be executed by a computing system, which may be provided as part of the stop controllers, stop indicators, or any other devices of the system 300. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 600 contains one or more shutdown control module(s) 608. In the example of computing system 600, computer system 601A includes the shutdown control module(s) 608. In some embodiments, a single performance and health monitoring module may be used to perform some or all aspects of one or more embodiments of the methods disclosed herein. In alternate embodiments, a plurality of shutdown control modules may be used to perform some or all aspects of methods herein.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general-purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A shutdown system for a drilling rig, the shutdown system comprising:
a plurality of rig system controllers configured to communicate with respective rig systems of a plurality of rig systems of the the drilling rig, to control operation thereof;
a stop controller in communication with the plurality of rig system controllers, wherein the stop controller is configured to selectively cause the plurality of rig system controllers to stop operation of the respective rig systems; and
a stop indicator in wireless communication with the stop controller, wherein the stop indicator is configured to transmit a stop message to the stop controller,
wherein the stop controller is configured to determine a type of stoppage, a particular system to shutdown, or a combination thereof based at least in part on the stop message, and, in response, to cause one or more of the plurality of rig system controllers to shutdown one or more of the rig systems.

2. The shutdown system of claim 1, further comprising a plurality of input/output (I/O) modules, each of the I/O modules being in communication with a respective one of the rig system controllers, and with the stop controller.

3. The shutdown system of claim 2, wherein the I/O modules are arranged in a ring network topology.

4. The shutdown system of claim 1, wherein the stop message received by the stop indicator is configured to indicate whether a blackout shutdown, an emergency stop, an e-stop of a particular rig system, or a maintenance isolation of a particular rig system, is requested.

5. The shutdown system of claim 4, wherein the stop controller is configured to determine that the stop message indicates a blackout shutdown is requested and, in response, cause the plurality of rig system controllers to shutdown all of the rig systems and to sound an alarm.

6. The shutdown system of claim 4, wherein the stop controller is configured to determine that the stop message indicates an emergency shutdown, and in response, cause the plurality of rig system controllers to shut down all non-emergency systems of the plurality of rig systems.

7. The shutdown system of claim 4, wherein the stop controller is configured to determine that the stop message indicates an e-stop of a particular rig system of the plurality of rig systems, and, in response, stop the particular rig system without stopping others of the plurality of rig systems.

8. The shutdown system of claim 1, wherein the stop indicator is a first stop indicator and is associated with a first identifier, the shutdown system further comprising a second stop indicator associated with a second identifier and in communication with the stop controller.

9. The shutdown system of claim 8, wherein the first and second stop indicators are each associated with an authority level, wherein an authority level requirement is associated with each type of stoppage, each of the rig systems, or both, and wherein the stop controller is configured to determine that the authority level of the first stop indicator meets or exceeds the authority level requirement to carry out the shutdown indicated by the stop message received therefrom.

10. A method for controlling stoppage of a drilling rig, comprising:
pairing a stop indicator with a type of stoppage, a rig system to shutdown, or both;
receiving a request to change the type of stoppage, rig system, or both paired with the stop indicator; and
in response to receiving the request, changing the type of stoppage, the rig system to shutdown, or both associated with the stop indicator, without changing a wiring of the drilling rig.

11. The method of claim 10, wherein pairing comprises associating the stop indicator with an identifier in a database, and associating the identifier with the type of stoppage, the rig system to shutdown, or both.

12. The method of claim 10, wherein pairing comprises pairing the stop indicator with a plurality of types of shutdowns, a plurality of rig systems, or both, such that a stop message identifying the stop indicator is configured to cause execution of any one of the plurality of types of shutdowns, any one of the plurality of rig systems, or both.

13. The method of claim 10, further comprising:
receiving a stop message from the stop indicator;
determining a type of stoppage, a rig system to shutdown, or both based at least in part on the stop message; and
executing the type of stoppage, shutting down the rig system, or both.

14. The method of claim 13, further comprising:
pairing the stop indicator with a shutdown authority level; and
after receiving the stop message, verifying that the stop indicator has a shutdown authority level sufficient to allow execution of the type of stoppage, shutting down the rig system, or both.

15. The method of claim 13, wherein determining the type of stoppage comprises determining that a black shutdown is requested based on the stop message, and wherein executing the type of stoppage comprises shutting down all rig systems of the drilling rig and activating an alarm.

16. The method of claim 13, wherein determining the type of stoppage, the rig system to shut down, or both comprises determining that an emergency shutdown is requested based on the stop message, and wherein executing the type of stoppage, shutting down the rig system, or both comprises shutting down all non-emergency rig systems of the drilling rig.

17. The method of claim 16, wherein executing the type of stoppage further comprises isolating ignition sources.

18. The method of claim 13, wherein determining the type of stoppage, the rig system to shut down, or both comprises determining that an e-stop of the rig system is requested, wherein executing the type of stoppage, shutting down the rig system, or both comprises shutting down the rig system.

19. The method of claim 18, wherein the rig system that is shutdown is a directly affected rig system, and wherein executing the type of stoppage comprises shutting down an indirectly affected rig system.

20. A non-transitory, computer-readable medium storing instructions that, when executed by one or more processors of a computing system, causing the computing system to perform operations, the operations comprising:
pairing a stop indicator of a drilling rig with a type of stoppage, a rig system to shutdown, or both, of the drilling rig;
receiving a request to change the type of stoppage, rig system, or both paired with the stop indicator; and
in response to receiving the request, changing the type of stoppage, the rig system to shutdown, or both associated with the stop indicator, without changing a wiring of the drilling rig.
